(19) United States
(12) Patent Application Publication
(10) Pub. No.: US 2002/0067312 A1
(43) Pub. Date: Jun. 6, 2002

(54) Miniaturized microwave antenna

(76) Inventor: Achim Hilgers, Aachen (DE)

Correspondence Address: Philips Electronics North America Corporation, 580 White Plains Road, Tarrytown, NY, 10591, US

(21) Appl. No.: 09/973,308

(22) Filed: Oct. 9, 2001

(30) Foreign Application Priority Data
Oct. 9, 2000 (DE) 10049844.2

(51) Int. Cl. H01Q 1/38; H01Q 1/24

(52) U.S. Cl. 343/700 MS; 343/702

(57) ABSTRACT

A miniaturized antenna is described with at least a ceramic substrate (10) and a metallization, particularly designed for use in the high-frequency and microwave ranges. The antenna is characterized in that the metallization is a surface metallization which is formed by a feed terminal (12) for electromagnetic energy to be radiated, by at least a first metallization structure (30), and by a conductor track (20) extending along at least part of the circumference of the substrate (10), which track connects the feed terminal to the at least one first metallization structure (30), which first metallization structure (30) comprises a first conductor track portion (31) extending from a side of the substrate lying opposite the feed terminal (12) towards the feed terminal and a first metallization pad (32). The antenna can be provided on a printed circuit board by means of surface mounting and has a great impedance and radiation bandwidth, so that it is particularly suitable for use in mobile telephones operating in the GSM and UMTS bands.

The invention relates to a miniaturized antenna with at least a ceramic substrate and a metallization, in particular for use in the high-frequency and microwave range. The invention further relates to a printed circuit board and a mobile telecommunication device with such an antenna.

Following the trend towards ever smaller electronic components, in particular in the field of telecommunication technology, all manufacturers of passive and/or active electronic components are intensifying their activities in this field. Particular problems then arise especially with the use of electronic components in the high-frequency and microwave technology fields, because many properties of the components are dependent on their physical dimensions. This is based on the generally known fact that the wavelength of the signal becomes smaller with increasing frequency, which again has the result that the supplying signal source is influenced in particular by reflections.

It is in particular the structure of the antenna of such an electronic device, for example a mobile telephone, which is more strongly dependent on the desired frequency range of the application than that of any other HF component. This is caused by the fact that the antenna is a resonant component which is to be adapted to the respective application, i.e. the operating frequency range. In general, wire antennas are used for transmitting the desired data. Certain physical lengths are absolutely necessary for obtaining good radiation and reception properties for these antennas.

So-called λ/2 dipole antennas, whose length corresponds to half the wavelength (λ) of the signal in open space, have optimum radiation properties. The antenna is composed of two wires each λ/4 long which are rotated through 180° with respect to one another. Since these dipole antennas are too large for many applications, however, in particular for mobile telecommunication (the wavelength for the GSM900 range is, for example, approximately 32 cm), alternative antenna structures are utilized. A widely used antenna in particular for the mobile telecommunication bands is the so-called λ/4 monopole. This is formed by a wire with a length of λ/4. The radiation behavior of this antenna is acceptable while at the same time its physical length (approximately 8 cm for GSM900) is satisfactory. This type of antenna in addition is characterized by a great impedance and radiation bandwidth, so that it can also be used in systems which require a comparatively great bandwidth. To achieve an optimum power adaptation to 50 Ω, a passive electrical adaptation is chosen for this type of antenna, as is also the case for most λ/2 dipoles. This adaptation is usually formed by a combination of at least one coil and a capacitance, which adapts the input impedance of the λ/4 monopole different from 50 Ω to the connected 50 Ω components by means of a suitable dimensioning.

Although antennas of this type are widely used, they do have considerable disadvantages. One of these is the passive adaptation circuit mentioned above.

Furthermore, the λ/4 monopoles cannot be directly soldered onto the printed circuit board because the wire antennas are mostly used as pull-out members, for example in mobile telephones. This means that expensive contacts are necessary for the information exchanged between the printed circuit board and the antenna.

A further disadvantage of antennas of this type is the mechanical instability of the antenna itself as well as the adaptation of the housing to the antenna made necessary by this instability. If a mobile telephone, for example, is dropped, the antenna will usually break off, or the housing is damaged in that location where the antenna can be pulled out.

Chip antennas with a substrate and at least one conductor are indeed known from EP 0 762 538. These antennas, however, have the disadvantage that at least portions of the conductor tracks extend inside the substrate, and that accordingly the substrate is to be manufactured in several layers and with a certain minimum size, which may be comparatively expensive. In addition, it is not possible with this arrangement of the conductor tracks to carry out an electrical adaptation of the conductor tracks to a concrete constructional situation in the finished state, because the conductor track is no longer accessible, or only partly accessible.

The invention accordingly has for its object to provide an antenna with at least a ceramic substrate and a metallization, in particular for use in high-frequency and microwave ranges, which has a high mechanical stability and is particularly suited for miniaturization.

Furthermore, an antenna is to be provided which renders it possible to dispense at least substantially with passive adaptation circuits and which is also suitable for surface mounting by the SMD (surface mounting device) technology on a printed circuit board.

Finally, an antenna is to be provided with a sufficiently great resonance frequency and impedance bandwidth for operation in the GSM or UMTS bands.

This object is achieved by means of an antenna of the kind mentioned in the opening paragraph which is characterized in that the metallization is a surface metallization which is formed by a feed terminal for electromagnetic energy to be radiated, at least a first metallization structure, and a conductor track extending along at least a portion of the circumference of the substrate, which track connects the feed terminal to the at least one first metallization structure, while said first metallization structure comprises a first conductor track portion extending from a side of the substrate opposite the feed terminal towards the feed terminal and comprises a first metallization pad.

This solution combines many advantages. Since the feed terminal is part of the metallization present on the surface of the substrate, no contact pins or similar items are required for feeding-in of the electromagnetic energy to be radiated. This means that the antenna can be provided by means of surface mounting (SMD technology) on a printed circuit board (together with the other components). The size of the antenna can also be further reduced thereby, and the antenna is mechanically substantially more stable and insensitive to external influences.

It was also found that passive circuits for impedance adaptation are unnecessary, because such an adaptation can be achieved through a change in the fully accessible metallization (for example achieved by laser trimming) with the antenna in the incorporated state. It was also found that the antenna has a surprisingly great impedance and radiation bandwidth.

Advantageous further embodiments of the invention are defined in the dependent claims.

The embodiments of claims 2 and 3 have the advantage that the manufacture of the substrate and the surface metallization is technically comparatively simple.

The embodiments of claims 4 and 8 have the advantage that the combination of two metallization structures, especially if they show only a small mutual difference, and/or a stack of several substrates with such structures enable a very flexible adjustment of the positions and distance as well as the widths of the resonance frequencies.

This holds in an analogous manner for the impedance of the antenna and its gradient over the frequency with regard to the embodiments of claims 7 and 8.

Further details, characteristics, and advantages of the invention will become clear from the ensuing description of preferred embodiments, given with reference to the drawing, in which:

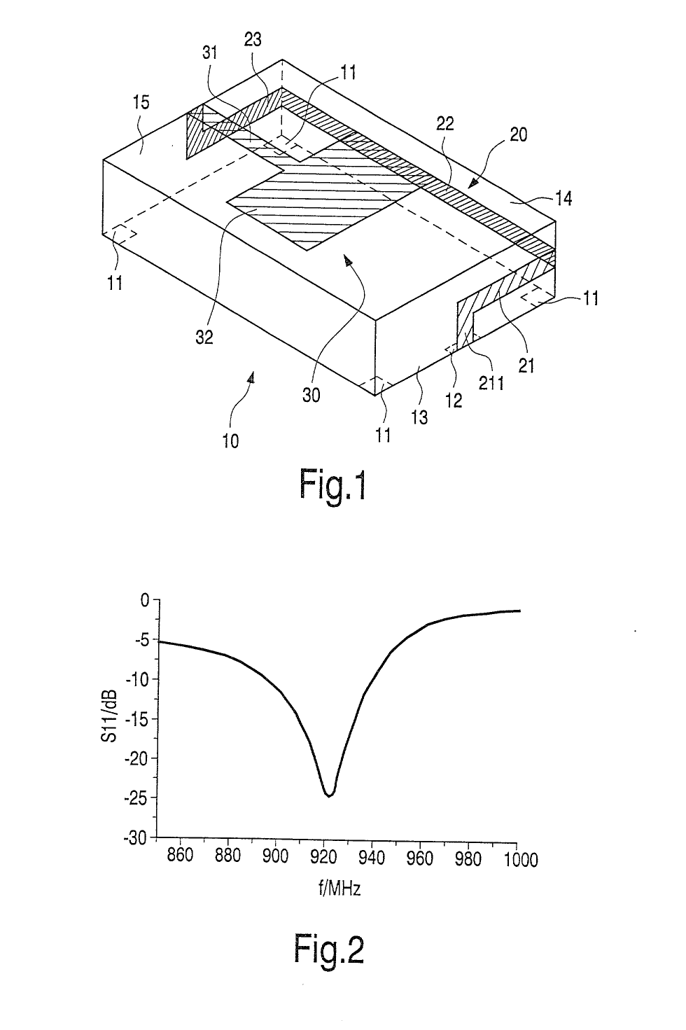

FIG. 1 diagrammatically shows a first embodiment of the invention;

FIG. 2 shows an impedance spectrum measured for this embodiment;

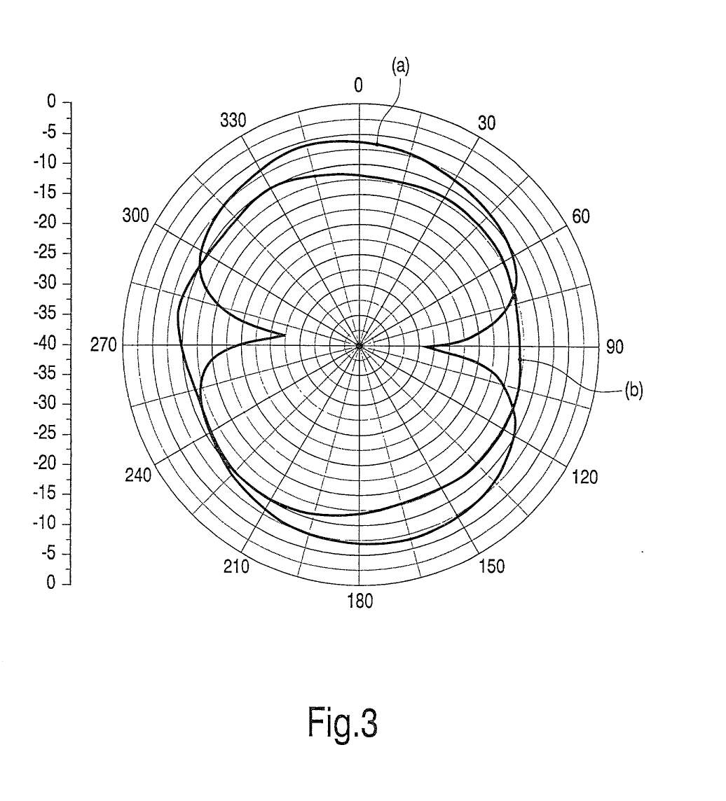

FIG. 3 shows a directional characteristic measured for this embodiment;

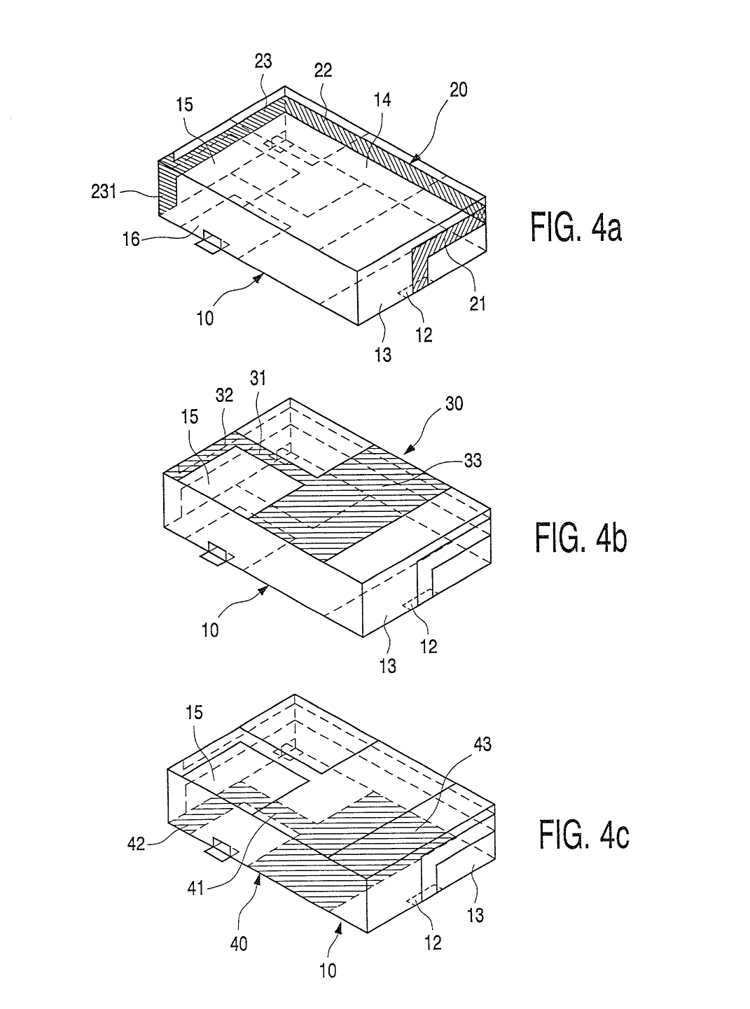

FIG. 4 shows a second embodiment of the invention;

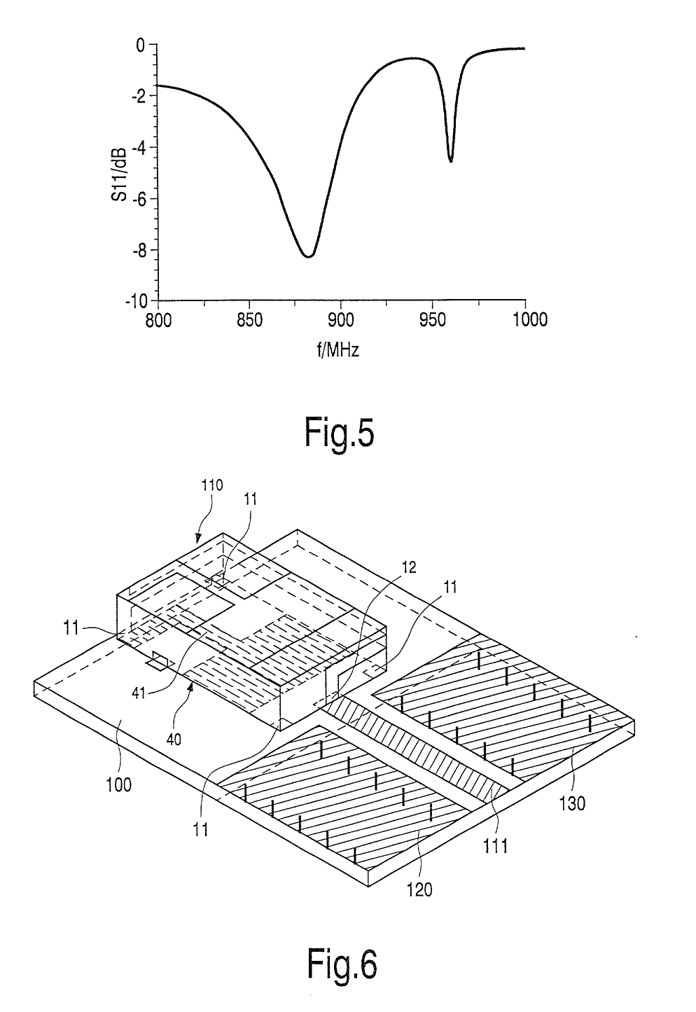

FIG. 5 shows an impedance spectrum measured for this embodiment; and

FIG. 6 shows a printed circuit board with an antenna according to the invention.

The embodiments to be described below comprise a substrate consisting of a substantially rectangular block whose height is approximately a factor 3 to 10 smaller than the length or width. Accordingly, the following description will refer to the upper and lower (larger) surfaces of the substrate as shown in the Figures as the first, upper and the second, lower surface, while the surfaces perpendicular thereto will be denoted the first to fourth side faces.

Alternatively, however, it is also possible to choose geometric shapes other than rectangular block shapes for the substrate, for example a cylindrical shape on which an equivalent resonant conductor track structure is provided, for example following a spiraling course.

The substrates may be manufactured by embedding a ceramic powder in a polymer matrix and have a dielectric constant of εᵣ>1 and/or a permeability value of μᵣ>1.

More in detail, a first embodiment shown in FIG. 1 shows a rectangular block-shaped substrate 10 with a resonant conductor track structure 20, 30. The substrate 10 is provided with several soldering points 11, by means of which it can be soldered on a printed circuit board by means of surface mounting (SMD technology), at the corners of its lower surface. Furthermore, a feed terminal 12 is present at the lower side in the central region of a first side face 13 in the form of a metallization pad which is soldered to a corresponding conductor region on a printed circuit board during mounting and through which the antenna is supplied with electromagnetic energy to be radiated. Starting from the feed terminal 12, a first portion 21 of a conductor track 20 extends vertically to approximately halfway the height of the first side face 13 and then continues in horizontal direction along the first side face 13 to a second side face 14. The conductor track then continues in horizontal direction along the second side face 14 at approximately half its height as a second portion 22, and as a third portion 23 along a third side face 15 lying opposite the first side face 13 at about halfway its height. In the central region of the third side face 15, the third conductor track portion 23 then goes in vertical direction up to the upper surface, as shown in the picture, where it is connected to a first conductor track portion 31 of a (first) metallization structure 30 provided on this surface.

The metallization structure 30 comprises the first conductor track portion 31, which extends substantially in longitudinal direction of the substrate in the direction of the feed terminal 12, and a substantially rectangular metallization pad 32 into which the first conductor track portion 31 issues.

The effective length of the structure between the feed terminal 12 and the metallization pad 32 here corresponds to approximately half the wavelength of the signal to be radiated in the substrate.

It was surprisingly found that this antenna combines several advantageous properties. On the one hand, the antenna has a particularly high impedance bandwidth, while on the other hand the antenna has a very homogeneous, quasi-omnidirectional space pattern.

In an embodiment realized for the GSM900 band (approximately 890 to 960 MHz), the dimensions of the ceramic substrate were approximately 17×11×4 mm , and the total length of the resonant structure formed by the conductor track 20 and the metallization structure 30 was approximately 39 mm. Passive impedance adaptation circuits can be omitted in the case of these dimensions, because the input impedance of the antenna is approximately 50 Ω.

The impedance gradient shown in FIG. 2 as a function of frequency and the directional characteristic shown in FIG. 3, where the curve (a) represents the horizontal and the curve (b) the perpendicular space characteristic, were found for this antenna. These curves show that the antenna behavior corresponds substantially to that of a dipole or monopole antenna.

This antenna is accordingly ideally suited for use in a mobile telephone device because it can be mounted (together with the other components) on a printed circuit board by means of surface mounting (SMD technology), whereby the manufacture is considerably simplified.

A further miniaturization in comparison with known wire antennas and a further increase in the frequency bandwidth, in particular of the first harmonic, can be achieved through changes in the shape of the ceramic substrate 10 and a further structuring of the resonant conductor track structure 20, 30.

A further advantage of this antenna is found in the fact that the input impedance of the antenna can be influenced and adapted to a concrete constructional situation through the creation of a slot 211 (air gap) between the feed terminal 12 and the first portion 21 of the conductor track. This is possible in the mounted state of the antenna, for example by laser trimming, whereby the width and/or the length of the gap (and thus the capacitive coupling between the feed terminal 12 and the resonant structure 20, 30) is increased with a laser beam until an optimum adaptation has been achieved.

To realize a preferred application of the antenna in a dual-mode or multi-mode mobile telephone device, the tuning is preferably performed such that the particularly great bandwidth of the first harmonic of the resonance frequency is used for covering the GSM bands. In this manner the antenna can also be constructed for use in the UMTS band (1970 to 2170 MHz).

FIG. 4 shows a second embodiment of the antenna. This antenna is formed by a substrate 10 with a resonant metal conductor track structure 20, 30, 40, which is substantially composed of three parts, i.e. a common conductor track 20 in accordance with FIG. 4a, a first metallization structure 30 on the upper (first) surface of the substrate as shown in FIG. 4b, and a second metallization structure 40 on the opposite, lower (second) surface of the substrate as shown in FIG. 4c, which structures 30, 40 are supplied by the conductor track 20. These three parts are shown separately in one picture each for clarifying the construction.

In detail, a feed terminal 12 in the form of a metallization pad is arranged again at the lower side of the substrate 10 in the region of the center of a first side face 13, which pad during surface mounting of the antenna is soldered onto a conductor region via which the antenna is supplied with electromagnetic energy.

Starting from the feed terminal 12, a first portion 21 of the conductor track 20 extends first vertically over the first side face 13 towards the upper surface and then horizontally up to a second side face 14. The conductor track 20 continues as a second portion 22 further along the second side face 14 and as a third portion 23 along a side face 15 opposed to the first side face 13, where the third portion ends in a T-shaped end piece 231 at an edge adjoining a fourth side face 16, perpendicular thereto.

In FIG. 4b, the first metallization structure 30 is connected to an upper leg of the end piece 231 extending towards the upper surface, and comprises a first portion 31 similar to the first embodiment, which portion extends in longitudinal direction of the substrate 10 in the direction of the feed terminal 12 and finally issues into a first, substantially rectangular metallization pad 33. The first portion 31, however, is connected to the upper leg of the end piece 231 via a second conductor track portion 32 which runs along the edge adjoining the third side face 15.

Finally, FIG. 4c shows a lower leg of the end piece 231 which extends towards the lower surface, to which the second metallization structure 40 is connected, which structure is formed in a similar manner as the first metallization structure 30 by a first portion 41 which extends in longitudinal direction of the substrate towards the feed terminal 12 and finally issues into a second, substantially rectangular metallization pad 43. Here, also, a second portion 42 is provided which runs along the edge adjoining the third side face 15 and which achieves a connection between the lower leg of the end piece 231 and the first portion 41.

The effective length of the structures between the feed terminal 12 and the first metallization pad 33 as well as between the feed terminal 12 and the second metallization pad 43 again corresponds to approximately half the wavelength of the signal to be radiated in the substrate.

This second embodiment of the antenna can also be mounted on a printed circuit board by means of surface mounting (SMD technology). Furthermore, a very homogeneous, quasi-omnidirectional space pattern both in horizontal direction and in the direction perpendicular thereto can be achieved again.

It was also found that two resonance frequencies are excited if the two metallization structures 30, 40 are slightly different, i.e. have different lengths or widths, with different couplings (for example by means of a gap 211 of variable width and/or length) to the joint conductor track 20, or with different dimensions of the first and second metallization pads 33, 43, which frequencies are mutually shifted in accordance with these differences. In that case, for example, the first metallization structure 30 will have a somewhat lower resonance frequency than the second metallization structure 40.

The number of these resonances can be increased in that, for example, one or several further substrates with identical or similar resonant conductor track structures 20, 30, 40 are provided on the substrate shown in FIG. 4. This is comparatively easy to realize in manufacturing technology, in particular with the use of multilayer technology. Furthermore, a further resonance can be generated between the substrates if a layered structure with two substrates is used.

The positions and distances of the resonance frequencies, which relates both to the fundamental modes and to the first harmonics of the resonance frequencies, may be adjusted as desired through a suitable choice of the dimensions of the substrates and of the resonant structures 20, 30, 40. This is also true for the adaptation of the antenna impedance to the feed terminal, for which purpose again an adaptation to a concrete constructional situation is possible through a suitable change in the capacitive coupling achieved by a variable gap 211, for example through lengthening and/or widening of the gap with a laser beam (laser trimming).

A further advantage of this embodiment arises in conjunction with the steepness of the impedance gradient in the region of the resonance frequencies. If the antenna is designed, for example, for a duplex operation, for which only two resonance frequencies are required (the transmission and reception frequencies), a filter effect can be achieved for the antenna between the transmission and reception frequencies through the steepness of this gradient, which may be utilized for reducing the requirements imposed on the filter circuits connected upstream or downstream, or even for eliminating these requirements completely. For this application, preferably, separate supplies are provided for the first and the second metallization structure 30 and 40.

It is possible also in this embodiment to realize a further miniaturization in comparison with known wire antennas through an adapted design of the ceramic substrate 10 and a corresponding structuring of the resonant conductor track structures 20, 30, 40.

In an embodiment realized for the GSM900 band (approximately 890 to 960 MHz), the dimensions of the ceramic substrate were approximately 17×11×4 mm³, and the total length of the conductor track 20 and the first metallization structure 30 and of the conductor track 20 and the second metallization structure 40 were each approximately 39 mm.

This resulted in the impedance spectrum gradient shown in FIG. 5, in which the two resonance peaks are clearly distinguishable.

FIG. 6 finally and diagrammatically shows a printed circuit board (PCB) 100 on which an antenna 110 according to the invention is provided together with other components in regions 120 and 130 of the printed circuit board 100 by means of surface mounting (SMD). This is done by planar soldering in a wave soldering bath or in a reflow process, whereby the solder points (footprints) 11 and the feed terminal 12 are connected to corresponding solder points on the board 100. This achieves inter alia an electrical connection between the feed terminal 12 and a conductor track 111 on the board 100, via which the electromagnetic energy to be radiated is supplied to the antenna.

The antenna according to the invention, given a suitable dimensioning, may also be used in the GSM1800 (DCS) band, in the UMTS band, and in the Bluetooth band (BT band at 2480 MHz).

The antenna may also be composed from several ceramic substrates with identical or dissimilar dielectric and/or permeability properties, each with its own surface metallization.

1. An antenna with at least a ceramic substrate and a metallization, in particular designed for use in the high-frequency and microwave ranges, characterized in that the metallization is a surface metallization which is formed by a feed terminal (12) for electromagnetic energy to be radiated, at least a first metallization structure (30), and a conductor track (20) extending along at least a portion of the circumference of the substrate (10), which track connects the feed terminal to the at least one first metallization structure (30), while said first metallization structure (30) comprises a first conductor track portion (31) extending from a side of the substrate opposite the feed terminal (12) towards the feed terminal and comprises a first metallization pad (32).

2. An antenna as claimed in claim 1, characterized in that the substrate (10) has the shape of a substantially rectangular block with two major surfaces and four smaller side faces, and in that the first metallization structure (30) is provided on a first major surface.

3. An antenna as claimed in claim 2, characterized in that the feed terminal (12) lies on the second main surface of the substrate (11) in the region of the center of a first side face (13), and the conductor track (20) extends with a first, second, and third portion (21, 22, 23) thereof along the first, a second, and at least part of a third side face (13, 14, 15), respectively, of the substrate (10).

4. An antenna as claimed in claim 2, characterized in that a second metallization structure (40) is provided on the second main surface of the substrate (10), which structure is connected to the conductor track (20) and comprises a first conductor track portion (41) extending from a side of the substrate opposed to the feed terminal (12) towards the feed terminal and comprises a second metallization pad (42).

5. An antenna as claimed in claim 4, characterized in that the first and the second metallization structure (30, 40) each comprise a second conductor track portion (32, 42) which each extend along an edge to the third side face (15) of the substrate (10) opposite to the feed terminal (12) and has its continuation in the respective first conductor track portion (31, 41).

6. An antenna as claimed in claim 5, characterized in that the third portion (23) of the conductor track (20) extends up to an edge of the third side face (15) where this joins a fourth side face (16) of the substrate (10), and merges into a T-shaped end piece (231) at its end, whose free legs are each connected to a respective second conductor track portion (32, 42).

7. An antenna as claimed in claim 1, characterized in that a gap (211) is provided in the conductor track (20) in a direction substantially transverse thereto, the length and width of said gap being chosen such that an impedance adaptation of the antenna to a concrete constructional situation is achieved.

8. An antenna as claimed in the preamble of claim 1, characterized in that it is formed from several ceramic substrates each with a surface metallization as claimed in the characterizing part of claim 1.

9. A printed circuit board, in particular designed for surface mounting of electronic components, characterized by an antenna as claimed in any one of the preceding claims.

10. A mobile telecommunication device, designed especially for the GSM or UMTS range, characterized by an antenna as claimed in any one of the claims 1 to 8.
